(19) United States
(12) Patent Application Publication
(10) Pub. No.: US 2002/0184573 A1
(43) Pub. Date: Dec. 5, 2002

(54) Method and device for configuring a functional unit with a temporary character in a communication network

(76) Inventors: Pascal Rousseau, Rennes (FR); Patrice Nezou, Bruz (FR); Mohamed Braneci, Rennes (FR)

Correspondence Address: FITZPATRICK CELLA HARPER & SCINTO, 30 ROCKEFELLER PLAZA, NEW YORK, NY, 10112, US

(21) Appl. No.: 10/118,952

(22) Filed: Apr. 10, 2002

(30) Foreign Application Priority Data
Apr. 12, 2001 (FR) 0105041

(51) Int. Cl. H04B 1/74

(52) U.S. Cl. 714/43

(57) ABSTRACT

In a communication network, a method of reading, by a controlling node, the configuration memory of a terminal connected to the network, the terminal being able to include at least one functional unit having a temporary character and having been configured according to a configuration method according to the invention. The method comprises: a step of sending, by the controlling node, a request to read configuration information relating to at least one functional unit of the terminal; a step of receiving, by the controlling node, the configuration information, and of saving this information; a step of analyzing the saved information and of determining a temporary character of at least one functional unit corresponding to this information; for each functional unit whose character is determined as being temporary, a step of storing the initial state of the functional unit, and of updating automatically the state stored according to the saved configuration information, by means of which the change in state of the functional unit is automatically taken into account in the controlling node.

The invention concerns a method of configuring a functional unit in a terminal connected to a communication network.

The invention also concerns a method of reading, by means of a controlling node connected to the communication network, the configuration memory of a terminal connected to the network, the terminal having at least one functional unit configured according to a configuration method in accordance with the invention.

The invention also concerns a method of processing a command generated by a controlling node connected to the network, the command being intended for a terminal connected to the network, the terminal having at least one functional unit configured according to a configuration method in accordance with the invention.

The invention also concerns a method of supplying configuration information, this information being saved by a controlling node in the communication network, and concerning functional units incorporated in a plurality of terminals connected to the network, the information having been obtained by a configuration method according to the invention.

The invention also concerns devices able to implement the aforementioned methods.

The invention applies particularly to a communication network whose architecture is based on IEEE 1394.

IEEE 1394 defines a high-speed serial bus technology intended to interconnect consumer electronic products and computer systems, such as for example digital televisions, personal computers, digital video recorders, digital camcorders, printers, facsimile machines, etc. IEEE 1394 (sometimes referred to as firewire) also defines isochronous and asynchronous communication modes for the transfer of data, which makes it ideally suited to multimedia applications.

Conventionally in such a communication system, the functional units of the devices, also referred to as terminals, connected to the bus, can be listed by a terminal conventionally referred to as a “controller”. For this purpose, the controller reads a memory, referred to as a “configuration memory”, incorporated in each of the items of equipment connected to the bus. According to the specifications defined by the “1394 Trade Association” (TA), this operation is known as the “discovery and enumeration protocol”.

The enumeration operation is performed only after a procedure of initializing the bus. This is triggered when a Bus_Reset signal appears on the bus. Such a signal may appear for several reasons such as, for example, following an error during a request generated by an application, following the connection of a new device to the bus or, conversely, following the disconnection of a device present on the bus.

When IEEE 1394 was created in 1995, it was commonly accepted that a terminal had a configuration memory fixed at the time of manufacture (that is to say the terminal has a unique address and a fixed configuration memory). However, recently, it became clear that this statement was no longer correct, and thus, in the new version of IEEE 1394 in the year 2000, the possibility was included for a given terminal to have a configuration memory which can change (that is to say the terminal has a unique address but a variable configuration memory).

This is because a functional unit can be loaded through another communication network, for example the Internet, or from a removable memory card. This is also the case when an item of equipment is upgraded. This then entails a consequential modification of the terminal configuration memory and a re-initialization of the system.

Likewise, when a functional unit is removed from a terminal, the terminal configuration memory is modified and the system reinitialized.

Thus, with the increasing capabilities of the devices for being able to change functionalities and being able to change configuration, in a network based on a serial bus of the IEEE 1394 type, the re-initialization (bus reset) operations will be more and more frequent, so as to allow the declaration of new functionalities on the bus and the validation of these configuration changes (addition, withdrawal, modification or upgrading of functionalities) by the controller or controllers present on the bus.

In this context, the increase in the bus reset operations has the drawback of, with each re-initialization, interrupting the bus operating mode. This drawback is all the more marked when the number of terminals on the bus having capabilities of dynamically modifying their configuration is high.

The present invention aims notably to afford a solution to this drawback, by proposing in particular a method of declaring functional units which integrates a temporary character of the said units.

To this end, the present invention concerns, according to a first aspect, a method of configuring a functional unit in a terminal connected to a communication network, the functional unit being configured in accordance with configuration information contained in a configuration memory of the terminal. The configuration memory is accessible remotely through the network by means of at least one controlling node.

This method is remarkable in that it comprises, when the functional unit to be configured has a temporary character relating to its operating state vis-à-vis the network, a step of creating, in the configuration memory, at least one first item of information characteristic of an action to be applied to the functional unit, and at least one second item of information specifying the nature of the temporary character of this action. By accessing the said first and second items of information, a controlling node can thus automatically take into account a change in state of the functional unit.

It is thus possible to preprogram changes in state of functional units and therefore services offered by these units, and to automatically inform controlling nodes on the network of this without it being necessary to reinitialize the network.

According to a particular characteristic of the invention, the action to be applied to the functional unit consists of changing the state of the functional unit relating to its availability on the network. Moreover, the nature of the temporary character consists in the definition of a duration relating to the validity in time of each possible state of the functional unit.

In addition to the decrease in the number of re-initializations on the network (for example Bus Reset), this characteristic makes it possible, for example, to automatically control in time authorizations for access to a given functional unit.

According to a preferred embodiment of the invention, the configuration method also includes a step of initializing the functional unit, this step comprising the creation of a memory register whose value indicates the current state of the functional unit, and a timer whose expiry triggers a change in state of the functional unit.

According to a second aspect, the present invention concerns a method of reading, by means of a controlling node connected to a communication network, the configuration memory of a terminal connected to the network, the terminal being able to include at least one functional unit having a temporary character, configured according to a configuration method as briefly defined above. The reading method is notable in that it comprises the following steps:

(a)—the sending, by the controlling node, of a request to read configuration information relating to at least one functional unit of the terminal;

(b)—reception by the controlling node of said configuration information, and saving of this information;

(c)—analysis of the saved information and determination of the temporary character of at least one functional unit corresponding to this information;

(d)—for each functional unit whose character is determined as being temporary, storage of the initial state of the functional unit, and automatic updating of the state stored according to the saved configuration information. The change in state of the functional unit is thus automatically taken into account in the controlling node.

In this way, the re-initializations of the network necessary for taking account of changes in configuration of the functionalities present on the network are minimized. This is because the variable (temporary) character of a functional unit is explicitly coded in the configuration memory and is taken into account by a controller, during an initial so-called “enumeration” procedure.

According to a particular embodiment, the step denoted (d) above includes the creation of a register whose value indicates the initial state of the functional unit, and the creation of a timer whose expiry triggers, in the controlling node, an updating of the value of said register.

According to a third aspect, the invention concerns a method of supplying configuration information. The information is previously saved by a controlling node in a communication network, and concerns functional units incorporated in a plurality of terminals connected to the network, this information having been obtained according to a configuration method as briefly described above. According to the invention, the information supply method is remarkable in that it includes the following steps, implemented for each of said terminals:

extraction, from the memory of the controlling node, of the terminal configuration information;

creation of a first window on a display screen, in which general information relating to the terminal is displayed, making it possible notably for a user to identify the terminal in question as well as the functional unit or units incorporated therein;

creation in the window of as many first distinct icons as there are functional units in the terminal, the specific information relating to a particular functional unit being accessible to the user by selecting the corresponding icon by means of an adapted selection device.

determination of the character, temporary or not, of each of the said functional units and the creation, for each of the functional units determined as having a temporary character, of an additional icon displayed close to the first corresponding icon, the additional icon indicating this temporary character, the information relating to the temporary character of the functional unit in question being accessible to the user by selecting the corresponding icon by means of an adapted selection device.

By virtue of such a method, implemented in an appropriate user interface, it becomes possible for a user to reprogram the functional unit.

According to a fourth aspect, the invention concerns on the one hand a method of processing a command by a controlling node connected to a communication network, the command being intended for a terminal connected to the network, the terminal having at least one functional unit with a temporary character and being configured according to a configuration method in accordance with the present invention. In addition the invention concerns a method of processing, by a terminal connected to a communication network, a command received via the network, the command being intended for a functional unit incorporated in the terminal, the functional unit having a temporary character and being configured according to a configuration method in accordance with the present invention.

The invention also relates to a device, such as a computer system, connected to a communication network, this device having means adapted to implement all or some of the plurality of methods as briefly defined above. The invention also relates to a communication network including at least one such device.

The present invention also concerns a computer program able to implement all or part of the plurality of methods briefly described above, when the program is loaded and executed in a computer system incorporated in or constituting a terminal or a controlling node connected to a communication network.

The invention also relates to an information carrier, such as, for example, a diskette or a compact disc (CD) containing such a computer program.

The advantages of this device, computer program and information carrier are identical to those of the various methods in accordance with the invention, as briefly disclosed above.

Other particularities and advantages of the invention will also emerge from the following description.

In the accompanying drawings, given by way of non-limitative example embodiments:

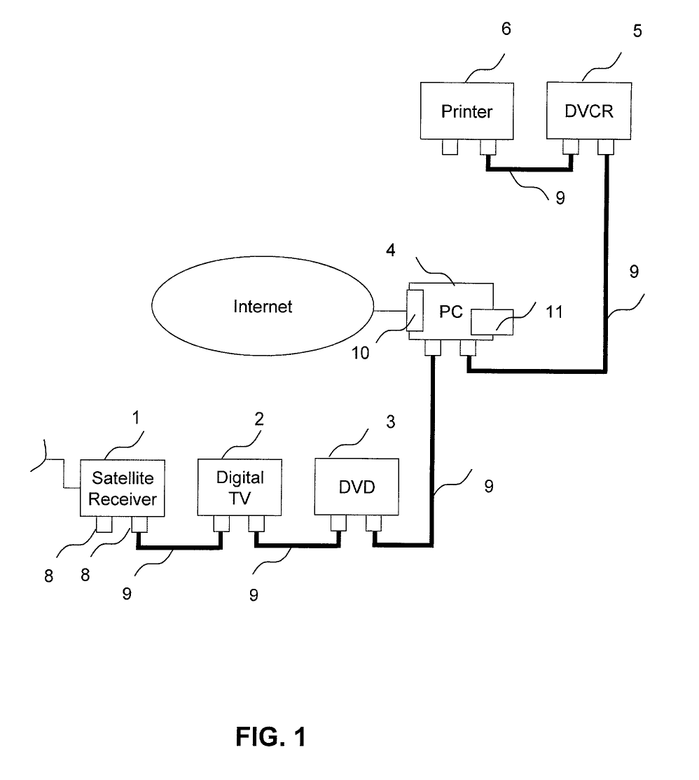

FIG. 1 is a block diagram depicting an IEEE 1394 system, composed of equipment or nodes connected to an IEEE 1394 serial bus, in which the invention can be implemented;

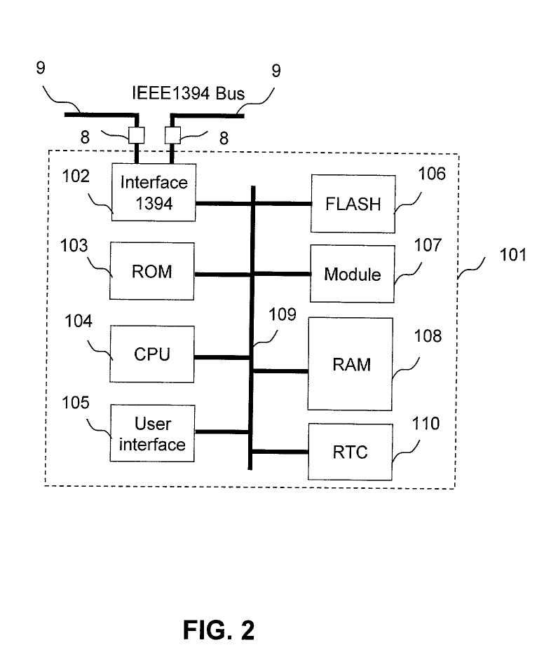

FIG. 2 is a block diagram depicting the internal architecture of a node, connected to the system of FIG. 1, in which the invention can be implemented;

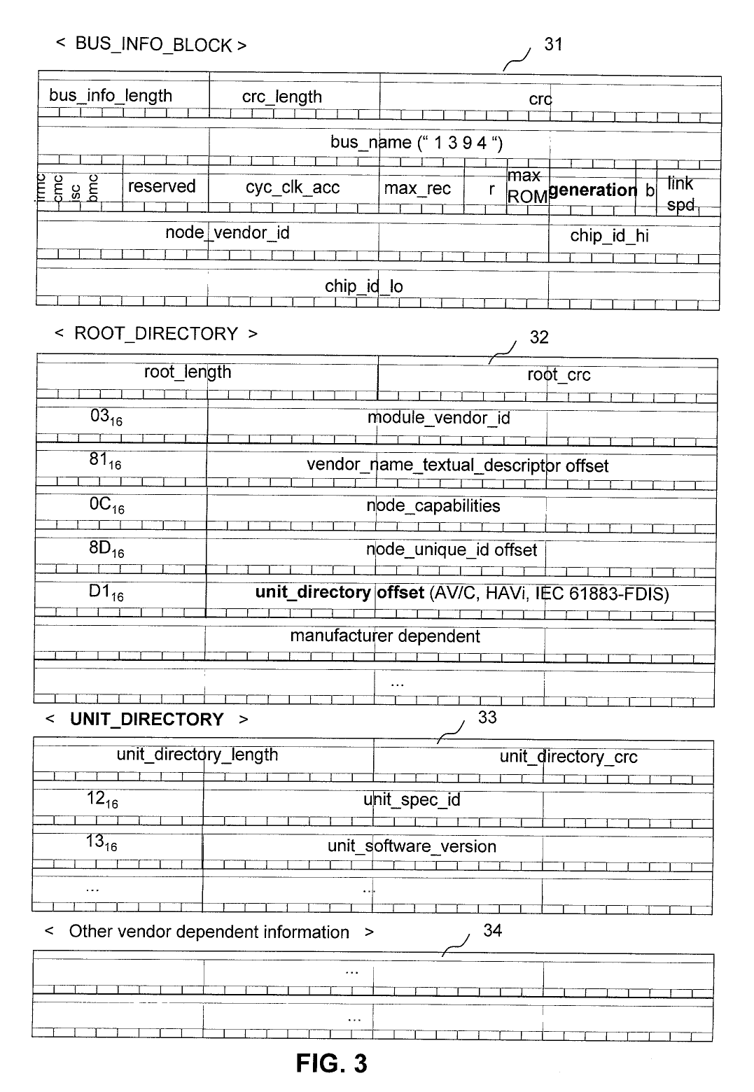

FIG. 3 depicts the conventional data structure of the configuration memory incorporated in a node as depicted in FIG. 2;

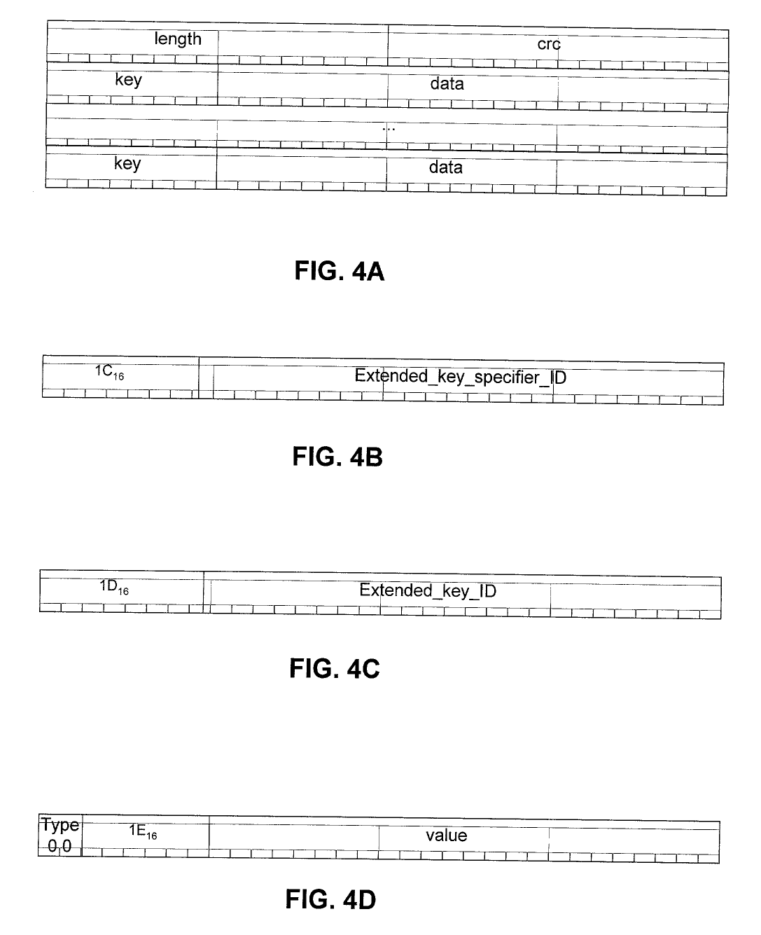

FIG. 4, composed of FIGS. 4A-4D, illustrates the way in which the configuration memory of FIG. 3 can be organized from the use of so-called “extended” keys;

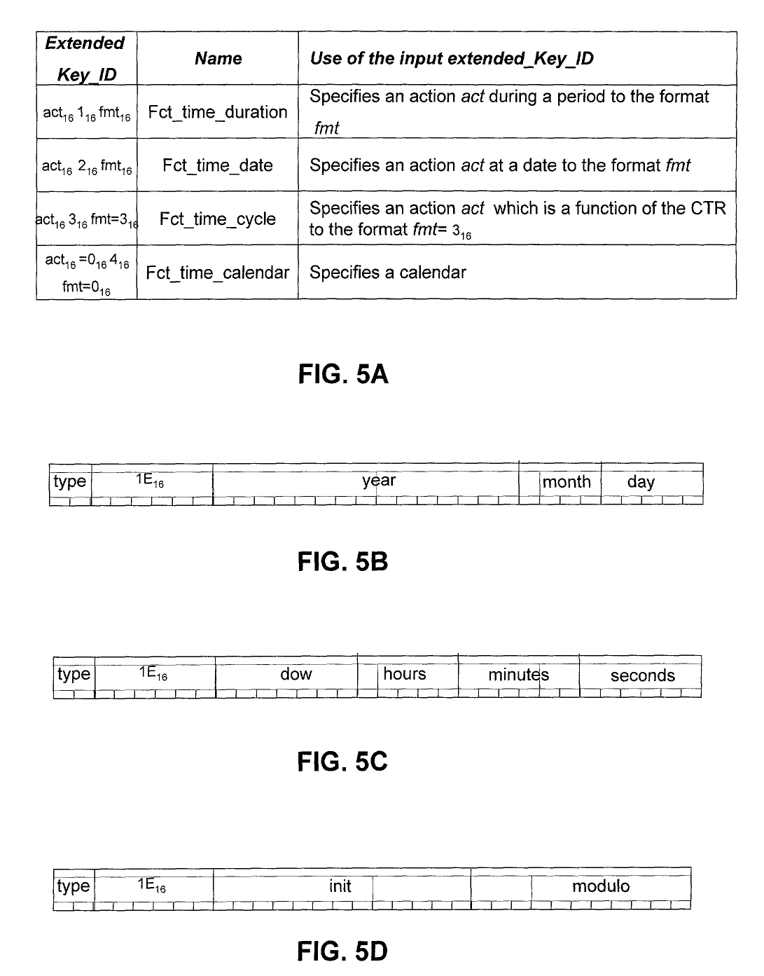

FIG. 5, composed of FIGS. 5A-5C illustrates the definition of a new set of extended keys by means of which it is possible to declare the temporary character of a functional unit in a node connected to the bus;

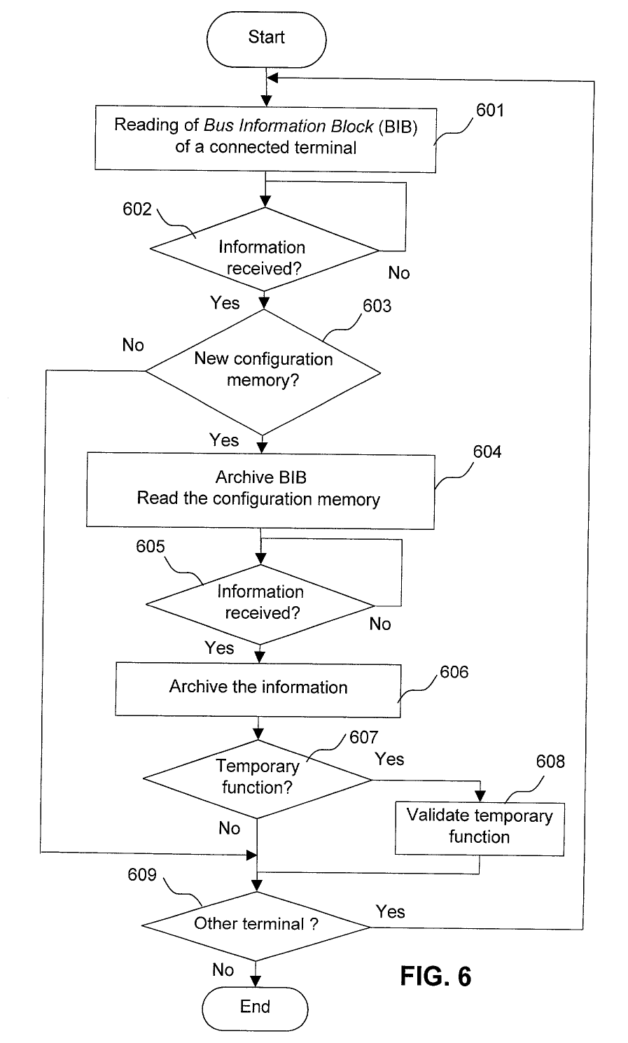

FIG. 6 is a flow diagram illustrating the processing steps executed, after initialization of the IEEE 1394 bus, by a controlling node in order to read and analyze the configuration memories incorporated in the equipment connected to the bus;

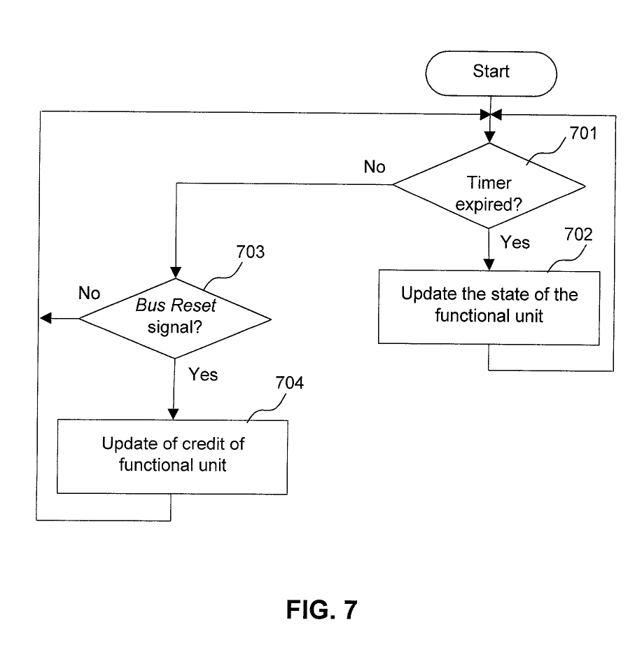

FIG. 7 is a flow diagram illustrating the process of updating the state information of a functional unit having a temporary character;

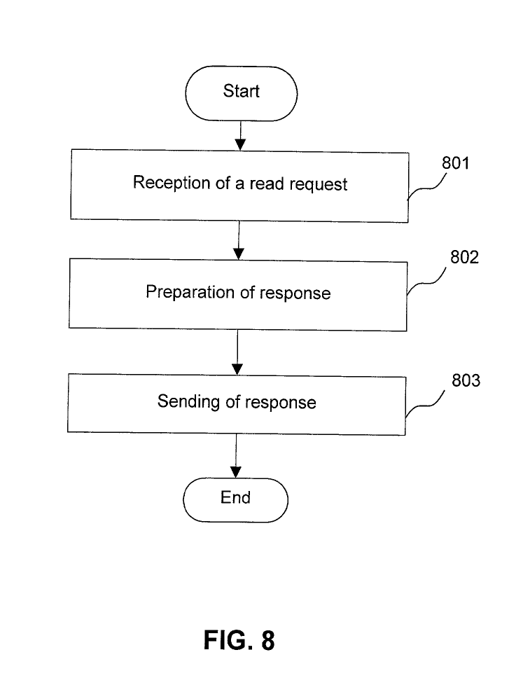

FIG. 8 is a flow diagram illustrating the processing carried out by a terminal connected to the bus, at the time of reception of a configuration memory reading request, coming from another terminal connected to the bus;

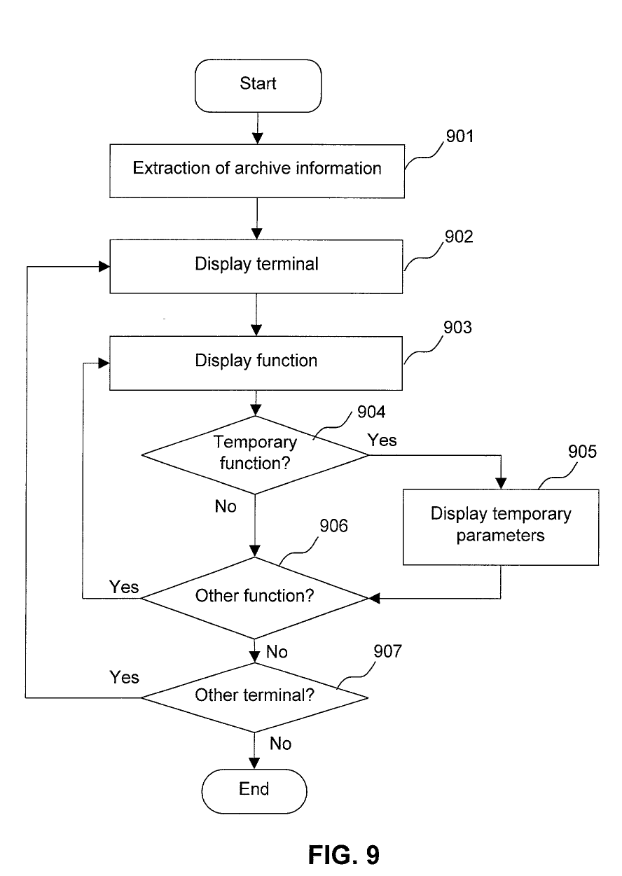

FIG. 9 is a flow diagram illustrating a method of supplying configuration information relating to the nodes connected to an IEEE 1394 bus, the method being implemented by a controlling device;

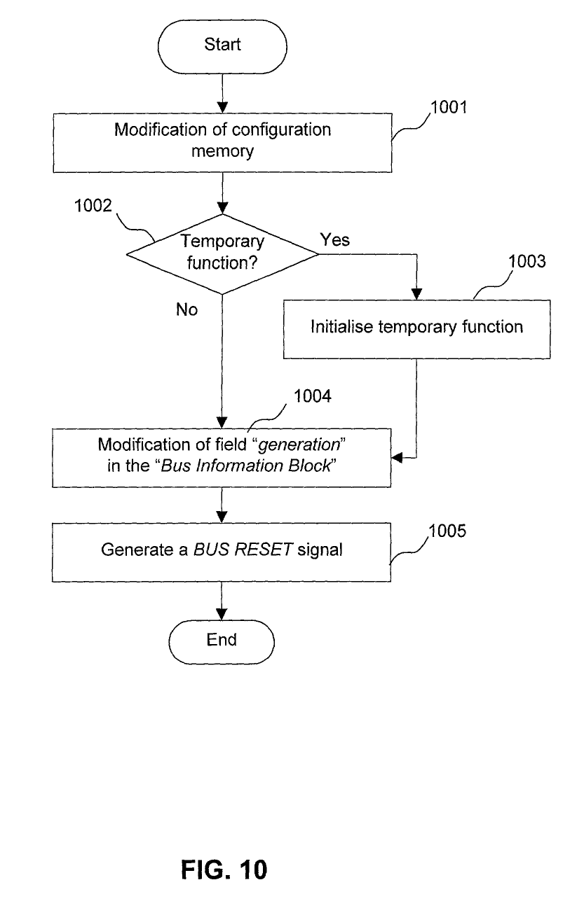

FIG. 10 is a flow diagram illustrating the procedure implemented in a terminal for performing a modification of its configuration memory;

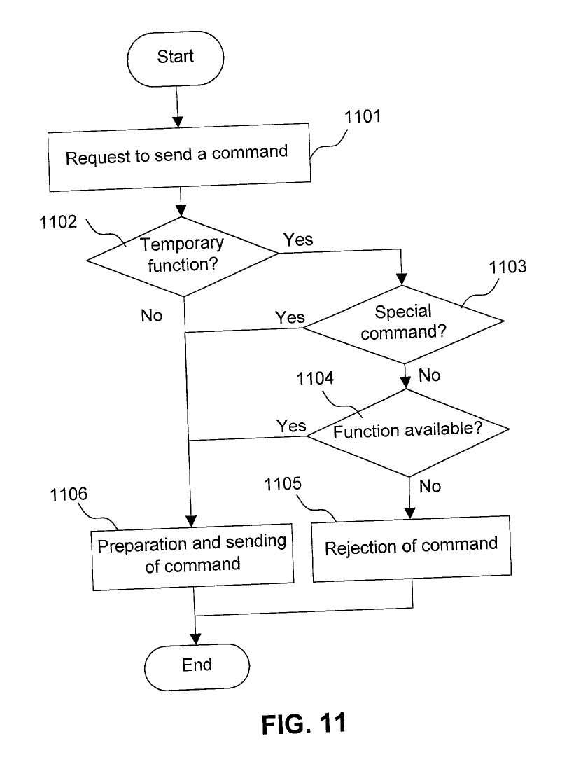

FIG. 11 is a flow diagram illustrating a process implemented by a controlling terminal in order to send a command, via an IEEE 1394 bus, to a terminal having a functional unit with a temporary character;

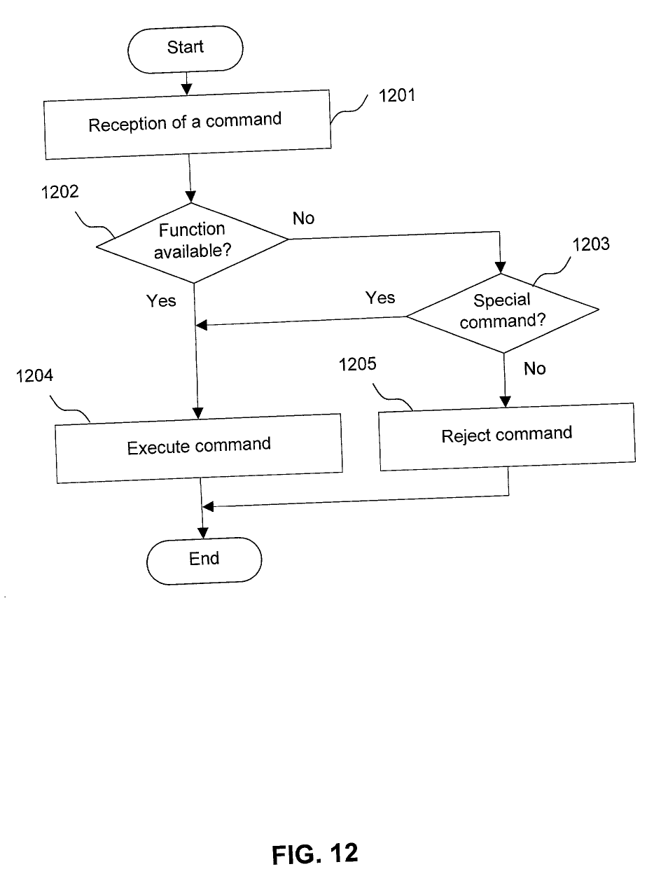

FIG. 12 is a flow diagram illustrating the process implemented by a terminal connected to an IEEE 1394 bus, at the time of reception of a command intended for a functional unit with a temporary character, incorporated in the terminal.

FIG. 1 is a block diagram depicting an example of a communication network in which the invention can be implemented. The network or IEEE 1394 system depicted in FIG. 1, is composed of equipment or nodes connected to an IEEE 1394 serial bus.

In this example, there are found in succession, connected to the IEEE 1394 bus, a satellite receiver 1, a digital television receiver 2, a digital video disc (DVD) drive 3, a personal computer (PC) 4 connected to the Internet by means of a modem 10 and having a memory card reader 11, a digital camcorder (DVCR) 5 and a printer 6. Each of these devices constitutes a node for this communication network built around the IEEE 1394 bus. In this example, the personal computer (PC) 4 and/or the digital television 2 can fulfil the role of a controlling node.

The IEEE 1394 bus, depicted here by connectors 8 and cables 9, is based on the IEEE 1394-1995 standard and its supplement IEEE 1394a-2000.

In addition, each of these nodes includes a configuration memory compatible with IEEE1212-2000 and IEEE 1394a-2000.

Briefly, IEEE 1394 describes a high-speed low-cost serial bus including:

a physical layer for different physical media;

a mechanism for access to the bus;

an automatic address allocation mechanism;

two isochronous and asynchronous communication modes;

bus control functions.

IEEE1212 for its part describes a control and state register architecture for a bus, including:

an addressing system;

a minimum message set;

a set of control and state registers;

the structure of a configuration memory with a set of keys.

Reference can be made to the specifications of these standards in order to obtain fuller details.

In relation to FIG. 2, a description will now be given of the internal architecture of an IEEE 1394 node as depicted in FIG. 1, in which the invention can be implemented according to a preferred embodiment. The architecture of the node is of the type of a computer system built around a processor.

As depicted in FIG. 2, the node 101 has a processor 104 responsible for executing the instructions of the programs stored in a non-volatile memory ROM 103 and in particular the program or programs necessary for implementing the invention. The data (that is to say the “variables”) necessary to the processor 104 for executing the programs are stored in a volatile memory RAM 108.

The node 101 has a module 107 containing one or more functional units. For example, the node consisting of the DVD reading device 3 (FIG. 1) has a video decoding functional unit MPEG2 and a disc reading functional unit DVD.

A memory space, constituting the configuration memory of the node, is associated with the module 107. The configuration memory contains the characteristic information related to the configuration of the functional unit or units contained in the functional module 107. It should be noted that a device 101 can have several modules 107.

The configuration memory of the node and a back-up thereof is provided in a memory component 106 of the non-volatile and re-writeable type, for example a FLASH memory. However, according to a variant implementation, the configuration memory can use the FLASH memory 106 and the ROM memory 103. In this case the ROM memory contains the configuration information which is frozen (that is to say fixed, static) whilst the FLASH memory contains the information liable to change (that is to say dynamic).

A local internal bus 109 connects together the different elements of the node 101 and thus ensures their interoperability.

The node 101 also has a user interface 105 which can comprise, for example, a screen, a keyboard, a mouse, a memory card reader, a modem, light emitting diodes (LEDs) or buttons. The user interface 105 enables a user to enter commands which will be transmitted to the processor (CPU) 104 by means of the local bus 109, before being interpreted by it. The node 101 also has a real-time clock 110 for supplying to the node a system date (date/hour/minute/second).

In addition, the node 101 has a communication interface 102 based on IEEE 1394-1995 and its supplement IEEE 1394a-2000. This interface allows the exchange of data between the functional module 107 of the node in question and a similar module of another node connected to the bus. Finally, the node 101 is connected to an IEEE 1394 serial bus (9) by means of connectors 8.

FIG. 3 depicts the conventional data structure of the configuration memory incorporated in a node as depicted in FIG. 2.

The structure of the configuration memory disclosed here, in relation to FIG. 3, is compatible with IEEE1212-2000 and IEEE 1394a-2000.

As depicted in FIG. 3, the configuration memory comprises notably a sub-part 31 called the “Bus Information Block”, BIB; a sub-part 32 called the “Root Directory”; one or more sub-parts called “Unit Directory”, which are optional; finally an area 34 relating to information specific to the manufacturer (Other vendor dependent information).

The sub-part Bus_Info_Block (BIB) 31 contains information which specify the characteristics of the communication bus, here of the IEEE 1394 type. The different fields relating thereto are defined in section 8.3.2.5.4 of IEEE 1394-1995 and in section 8.3.2.5 of the supplement IEEE 1394a-2000.

It should be noted that, amongst these fields, the “generation” field (in bold in the figure) is used for indicating a change in the configuration memory. For this purpose, the data which it contains is incremented at each modification of the configuration memory, without however being able to take a value already used during the previous 60 seconds.

The sub-part Root_Directory (32) contains general information (for example the manufacturer) on the terminal corresponding to the configuration memory in question, as well as pointers, for example in the field “unit_directory_offset” (in bold in the figure), pointing to more detailed information.

In order to obtain more information on the different fields which can be used in this sub-part, reference can be made to section 7.6 of IEEE1212-2000.

In addition, other documents supplement the general conditions contained in the specifications of IEEE1212-2000 and IEEE 1394a-2000. Thus reference can be made to the document “Configuration ROM for AVIC devices 1.0”, dated Mar. 15, 2000, published by the “1394 Trade Association” (TA), and to the document “The HAVI Architecture version 0.8”, dated May 11, 1998, published by the HAVI Consortium. In these documents, additional rules are defined for the interoperability of the equipment complying with their respective specifications.

In accordance with IEEE1212-2000, the information contained in the sub-parts Root Directory (32) and Unit Directory (34) of the configuration memory illustrated here are structured by means of the use of keys. A key is an indicator of the data item which follows it, the pair {key, data} thus forming a “whole” which can be understood, for example, by an external controlling device. Each key is identified in the configuration memory by an identifier.

Thus, in the sub-part Root Directory depicted in FIG. 3, the identifier ‘03’ (in hexadecimal, that is to say “0000 0011” in binary in 8 bits) identifies the key corresponding to the manufacturer module (module_vendor_id). The field which follows the 8 bits corresponding to the identifier of the key contains the data corresponding to the manufacturer module.

Likewise, in the sub-part unit_directory 33 of the configuration memory, the keys having the identifier, respectively, ‘12’ and ‘13’ (in hexadecimal) preceding, respectively, the data item defining the functional unit type (field unit_spec_id), and the one defining the version of the software code corresponding to this functional unit (field unit_software_version).

As will be detailed in the remainder of the disclosure, according to the preferred embodiment of the invention described here, use will be made principally of the field “generation” of the part BIB 31 of the configuration memory and a specific set of so-called “extended” keys defined in the sub-part “Unit_Directory” (33) of the configuration memory.

FIG. 4 illustrates the way in which a configuration memory as depicted in FIG. 3 is structured, in relation to the use of “extended keys” as defined in the new revision of IEEE1212-2000 (section 7.5.2).

FIG. 4A sets out the format of a sub-part of a configuration memory relating to the use of keys, as described above in relation to FIG. 3. As depicted in FIG. 4A, such a subset of memory (for example the sub-part unit_directory), first of all has a field “length” containing an item of information corresponding to the size of the subset in question, followed by a field “crc” (Cyclic Redundancy Checks) containing information relating to error detection. Next, the sub-part in question has successive “pairs” {key, data} (fields key and data), each pair representing a “line” of the sub-part in question. For example, a key “vendor” will be followed by the name of the vendor in text or coded form, according to the definition of the key.

In the new revision of IEEE1212-2000 section 7.5.2, the concept of extended key is defined. According to this concept, it is possible to define a set of extended keys associated with a particular entity. Each set of extended keys uses several conventional “lines” or pairs {key, data} of a sub-part of the configuration memory, as defined above.

Each set of extended keys includes first of all, using a first conventional pair {key, data}, an item of information indicating that the information which follows identifies a set of keys, followed by an identification of the organization or vendor responsible for the set of keys in question. This set of keys is valid solely for the subset in question (for example a “Unit_Directory”) as long as another set of keys is not chosen.

In a conventional pair {key, data} following in memory, it is first of all identified that the information which follows identifies a particular extended key, and then the identifier of the key is given. Finally, in a third pair {key, data}, it is first of all identified that the data item which will follow is the value given to the extended key identified in the previous pair {key, data}, and then this value is supplied. There are as many “third pairs” {key, data} as there are extended keys in the set in question.

FIGS. 4B-4D illustrate the format of a set of extended keys including a single key. Thus, in this example, the set of extended keys uses 3 successive pairs {key, data}.

In FIG. 4B, the field key containing the value ‘1C’ in hexadecimal (‘00011100’ in binary) indicates that the field data which follows (field Extended_Key_Specifier_ID) identifies a set of extended keys.

In FIG. 4D, the field key contains the value ‘1D’ in hexadecimal indicating that the field data which follows (field Extended_key_ID), identifies a particular extended key in the set (in this example, this extended key is unique).

Finally, in FIG. 4C, the field key comprises a first part “type” indicating the location in the memory of the field data which follows (type=‘00’ in binary, means that the field data is contiguous). The field key comprises a second part, equal to ‘1E’ in hexadecimal in 6 bits (‘01 1110’ in binary), indicating that the field data which follows (field value), contains the value associated with the extended key identified in the field Extended_key_ID which precedes.

FIG. 5, composed of FIGS. 5A-5D, illustrates the definition of a new set of extended keys by means of which it is possible to declare the temporary character of a functional unit in a node connected to a serial bus of the IEEE 1394 type.

This set of extended keys uses, in a configuration memory, the format described above in relation to FIG. 4. In addition, this set of keys makes it possible, according to the invention, to specify a type of action with, for example an activation date or an execution duration, for the functional unit corresponding to the subset (Unit_Directory) in which this set is present. An action may for example be the validation or invalidation of the corresponding functional unit.

The table in FIG. 5A summarizes a set of extended keys which can be used in accordance with the invention for specifying actions related to the temporary character of a functional unit.

The column in the table referenced by the label “Extended_Key_ID” corresponds to the field with the same name depicted in FIG. 4C. In this column, each line in the table uniquely identifies a particular extended key in the set. The column in the middle referenced by the label “Name” supplies the name allocated to the key identified by the corresponding data item in the left-hand column. Finally, the right-hand column referenced by the label “Use of the input Extended_Key_ID”, specifies the type of action generated by the use of the key.

Thus on the first row of the left-hand column in the table a first key is identified by the identifier: “act1₆₁fmt₁₆”, where

“act₁₆” is a field whose variable value (hexadecimal) indicates the type of action to be implemented; and

“fmt₁₆” is a field whose variable value (hexadecimal) makes it possible to parameterize in time the type of action defined by the data act₁₆.

This key is called (column in the middle) “Fct_time_duration”, and, according to the definition of the right-hand column in the table, this key makes it possible to specify an action (whose type is parameterized by the field “act”) applied during a period whose format is parameterized by the field “fmt”.

Likewise, on the second line in the table, a second key identified by the identifier “act₁₆2₁₆fmt₁₆” is called “Fct_temp_date”, and makes it possible to specify an action (whose type is parameterized by the field “act”) which is triggered by a date whose format is parameterized by a field “fmt”.

According to third line in the table, a third key identified by “act₁₆3₁₆fmt₁₆”, with fmt having a fixed value equal to ‘3’ (in hexadecimal), is called “Fct_temp_cycle” and makes it possible to specify an action (whose type is parameterized by the field “act”) as a function of a register known as “cycle time register” (CTR) and to the format parameterized by the field “fmt”. The action specified is then an action of a periodic type related to the value of a field “cycle” of the register CTR of the terminal in question.

The register CTR is contained in a local memory of the relevant terminal connected to the bus, and contains a time value, contained in the field cycle for defining a date common to all the nodes present on the bus. The register CTR is timed by a hardware quartz-based clock present in the device. In a preferred implementation, this clock has a frequency of 24.576 MHz. Periodically the time value contained in each register CTR is synchronized by a clock master system present on the bus. In this way, all the systems present on the bus have the same time reference.

Returning to FIG. 5A, on the last line in the table, a fourth key identified by “act₁₆4₁₆fMt₁₆” with the fields act and fmt having a fixed value equal to ‘0’ (in hexadecimal), and called “Fct_time_calendar”, makes it possible to specify a calendar.

As disclosed above, according to the value attributed to the fields act and fmt, the action specified by the key concerned is different. The interpretation of the values attributed to these fields makes it possible to define the format of the field “value” of the extended key in question, as described above in relation to FIG. 4D.

By way of example, the interpretation of the fields act and fmt is given below as a function of certain predetermined values.

| Values attributed to the field “act” | |
|---|---|
| act = ‘0’ | non-significant value. |
| act = ‘1’ | functional unit not available. |
| act = ‘2’ | functional unit available. |
| act = other | available for future allocation. |
| Values attributed to the field “fmt” | |
| fmt = ‘0’ | non-significant value. |
| fmt = ‘1’ | format: year/month/day. |
| fmt = ‘2’ | format: day of the week/hours/ |
| | minutes/seconds. |
| fmt = ‘3’ | number of isochronous cycles. |
| fmt = other | available for future allocation. |

FIGS. 5B-5D illustrate different formats of the field “value” as defined in FIG. 4D, according to the value allocated to the field fmt.

Thus FIG. 5B illustrates the format of the field “value” of an extended key in accordance with the invention, when the field fmt is equal to ‘1’, that is to say when it corresponds to a format: year/month/day.

FIG. 5C illustrates the format of the field “value” of an extended key in accordance with the invention, when the field fmt is equal to ‘2’, that is to say when it corresponds to a format: day of the week (dow)/hours/minutes/seconds.

By way of example, if the “sub-field” dow of the field value is equal to ‘0000000’ (in binary in 7 bits), this means that the field is not used. If the sub-field dow is equal to ‘1000000’, this means “Monday”; if dow is equal to ‘0100000’, this means “Tuesday”; if dow is equal to ‘1100000’, this means “Monday and Tuesday”.

FIG. 5D illustrates the format of the field “value” of an extended key in accordance with the invention, when the field fmt is equal to ‘3’, that is to say when it corresponds to a periodic action in the time applied to the functional unit to which this key relates. The field “value” of this key includes in particular a sub-field “init” indicating an initial value and a sub-field “modulo” for defining the periodicity of the action. More specifically, the action previously defined by the field act (see above) is active when the following equation is satisfied: the value of the field cycle of the register CTR modulo 2^{x} (2 to the power of X) is equal to the value of the sub-field init, with X being the value (decimal) of the sub-field modulo.

The fourth key, called “Fct_time_calendar”, defined in FIG. 5A, makes it possible, by specifying a calendar, to combine the use of the three previous keys sequentially in time. Just like the other extended keys, this key has a field value in a conventional pair {key, data} as illustrated in FIG. 4D, the field value indicating the length of the block defining the calendar.

With reference to FIG. 6, a description will be given of the processing steps executed by a controlling node, after initialization of the IEEE 1394 bus, in order to read and analyze the configuration memories incorporated in the equipment connected to the bus.

At each bus reset, the controller archives in its local memory the list of nodes (terminals) present (that is to say connected) on the bus. This list contains, for each node, an identifier of the node and its logic address. The list can be stored in non-volatile memory (for example FLASH memory 106, FIG. 2) or in RAM memory (108). In the latter case, the list is copied into non-volatile memory before the controller is stopped.

Next, as illustrated at step 601, for each item of equipment whose address is present in the aforementioned list of terminals, the controller makes, through the IEEE 1394 bus, a request to read the subset “Bus Information Block” (BIB) of the configuration memory of the equipment in question.

Then the test of step 602 is passed to, in which the controller awaits a response to its read request. When the controller receives a response to its read request—that is to say a packet is sent by the node in question containing the information BIB of this node—step 603 is passed to in which the controller checks whether it has already archived the configuration memory of this equipment. This is carried out by checking in the sub-assembly “Bus Information Block” that, for the pair node_vendor ID and chip_ID (cf. FIG. 3, 31) in question, the associated field generation has not changed since the previous reading of the sub-assembly “Bus Information Block” relating to this node.

In the negative, test 609 is passed to in order to check whether there exists another item of equipment connected to the bus whose sub-assembly “Bus Information Block” has not yet been read. In the negative, this procedure ends; in the contrary case, the previously described step 601 is returned to.

In the affirmative to test 603, that is to say when the configuration memory of the node in question has changed or if it is a case of the first reading of the subset “Bus Information Block” (which is detected by an unknown pair node_vendor ID and chip_ID), step 604 is passed to.

At step 604, the controller commences by archiving (that is to say storing) the received subset BIB, and then it performs the operation proper of reading the configuration memory of the node in question. For this purpose, the controller makes, through the IEEE 1394 bus, a request to read the part of the configuration memory associated with the previously archived subset “BIB”, it is a case in particular of the subset “Unit_Directory” (cf. FIG. 3, 33) of the configuration memory.

The test step 605 is then passed to, in which the controller awaits a response to this request. When the response to the read request is received by the controller, the latter, at step 606, archives in memory the copy of the configuration memory contained in the response coming from the equipment in question.

At the following step 607, it is determined whether the copy of the configuration memory received and archived relates to a temporary functional unit. To this end, the (copy of the) configuration memory is run through in order to detect therein at least one extended key of the type described previously in relation to the table in FIG. 5A.

In the affirmative, the configuration memory is analyzed. Then, at step 608, for each temporary functional unit identified, the validation of this unit is proceeded with. For this purpose, a register representing the state thereof is initialized, and a timer making it possible to detect the next change in state of a functional unit in question is triggered. Finally, still at this step, an update procedure (described below in relation to FIG. 7) is activated at the end of the aforementioned timing. The test step 609 is then passed to.

Conversely, if no functional unit with a temporary character is identified, the test step 609 is directly passed to, in which it is checked whether there is another item of equipment connected to the bus whose subset “Bus Information Block” has not yet been read, that is to say if the above-mentioned list of the nodes connected to the bus has not yet been fully run through. If such is the case, step 601 is passed to again and the process recommences as described above. On the other hand, if all the nodes connected to the bus have been tested, the procedure ends there.

As mentioned previously, there is implemented in the controlling node, for each temporary functional unit relating to a given item of equipment connected to the bus:

on the one hand a timer, whose initial value is fixed according to the format of the field “value” of the extended key corresponding to this functional unit in the configuration memory of this equipment (see above description relating to FIG. 5);

on the other hand a register, hereinafter referred to as a “state register”, whose value indicates the state of the functional unit;

finally a process of updating the state of the functional unit is activated at the end of the timer (that is to say when the duration coded in the timer has expired).

The state of the functional unit in question is determined by the type of action associated with the extended key which manages this unit. Thus, in the example given above in relation to FIG. 5A, according to the value attributed to the field act of the key in question, the state of the unit can be available (act=‘2’) or non-available (act=‘1’). However, it is possible to provide for other values of this field having other meanings, such as for example “partially available”.

The updating process, executed in the controller, enables the latter to be continuously “informed” of the changes in state of functionality of all the devices connected to the bus, whose supervision it provides (without generating exchanges of additional control packets and reducing the number of bus resets). Thus, by way of example, the controller can have the function of remotely controlling a device such as a digital television or a camera, connected to the bus.

In relation to FIG. 7, a description will now be given of the process of updating the state information of a functional unit having a temporary character. This process is implemented during step 608 of FIG. 6, as disclosed above. It should be noted that a similar process is also implemented in an item of equipment including a temporary functional unit, in order to manage the temporary character of this functionality (see below, description in relation to FIG. 10).

As illustrated in FIG. 7, the process of updating the state of a functional unit commences with a test step 701 in which it is determined whether or not the timer associated with the functional unit in question has expired.

If such is the case, this means that the functional unit, in the device storing it, must change state in accordance with the condition coded in the field value of the corresponding extended key. In this case, at step 702, this state is updated, in accordance with the extended key of this unit, by modifying the value contained in the state register dedicated to this unit in the memory controller. Next, step 701 is returned to, in which the timer is tested.

On the other hand, at step 701, if the timer has not run out, step 703 is passed to, in which it is determined whether an initialization signal for the bus (Bus Reset) has been received in the controller. In the negative, step 701 is returned to.

If on the other hand a signal Bus_Reset has been received in the controller via the bus, then step 704 is passed to, in which the time credit relating to the functional unit in question is updated, when an extended key is used of the type Fct_time_duration, as defined above in relation to FIG. 5A. Then the test step 701 is passed to again.

It should be noted that a signal Bus_Reset is emitted on the bus, in particular when a functional unit is put in service in a terminal connected to the bus, and when a new controller is put in service on the bus.

According to a first implementation, the appearance of a signal Bus_Reset on the bus has no influence on the running of the timer associated with the functional unit in question. When the bus is restarted, the configuration memory (that is to say the timer) of the functional unit is updated (step 704) with the time value remaining to run before the next change of state (time credit).

By way of variant, according to another implementation, the appearance of a signal Bus_Reset on the bus causes the re-initialization of the timer of the functional unit in question, the update step (704) then consists of resetting the timer to its initial value, according to the configuration memory (the initial value defined by the field value of the corresponding extended key).

FIG. 8 depicts the processing effected by a terminal (controller or otherwise) during the reception of a request to read its configuration memory coming from another terminal connected to the bus (controller or otherwise). In particular, it is a case of a read request as described above, in relation to FIG. 6, step 601.

As illustrated in FIG. 8, the process begins, at step 801, with the reception in the terminal in question of a request to read its configuration memory. This read request, in the context of the embodiment disclosed, consists of an asynchronous data packet of the type “Read_Request” as defined by IEEE 1394-1995, and received by the terminal in question, through its IEEE 1394 physical interface (FIG. 2, 102). Still during the same step, the request received is stored locally in memory, so as to analyze it.

Once the request has been analyzed, the response is produced, at the following step 802. This response, according to the embodiment described, consists of an asynchronous data packet of the type “Read_Response” as defined by IEEE 1394-1995. This response takes account of the information contained in the read request and in particular the source and destination addresses and the reading address.

Next, step 803 is passed to, in which the response produced is sent over the IEEE 1394 bus, through the IEEE 1394 connection controller and the IEEE 1394 physical interface, to the read request emitter.

The asynchronous packets used for the read request and for the associated response are defined in section 6.2.2 of IEEE 1394-1995.

In relation to FIG. 9, a description will now be given of a method of supplying configuration information concerning a set of nodes connected to an IEEE 1394 bus.

This method is implemented by a controller for supplying to a user information relating to the functional units of the nodes supervised by the controller. To this end, the controller uses a user interface (bearing the reference 105 in FIG. 2), of the graphical interface type, having for example a display screen. The user interface can thus present information in a text or graphics form with the use of multiwindowing or not. In the preferred embodiment of the invention, the graphical interface uses multiwindowing.

As illustrated in FIG. 9, the display process commences with a step 901, in which the controller reads the configuration information relating to the different nodes, which were previously archived in its memory, according to the procedure described above, in relation to FIG. 6.

At the following step 902 the general information concerning a first terminal are extracted and displayed on the screen. For this purpose, a new graphics window is created on the screen, in which the general information relating to this terminal is displayed, making it possible notably for the user to identify the terminal in question, and including for example the list of functional units incorporated in the terminal.

At the following step (903), the display of the information concerning a first functional unit (designated in the figure by the term “function”, for the purpose of simplification) is proceeded with. For this purpose, an icon is displayed, and the detailed information concerning this function (for example input port, output port, name, vendor, performance etc) are accessible to the user, by clicking for example on the icon with a mouse.

The following step 904 is a test step, in which it is determined whether this functional unit has a temporary character. In the negative, the following step (906) is passed to.

Conversely, if such is the case, an additional icon (representing for example a chronometer) indicating this temporary character is displayed (step 905) on the screen, close to the icon relating to the functional unit in question. The user can then consult the information relating to the temporary character of the unit in question, for example by clicking on the additional icon. Moreover, so that the user can immediately be informed of the state of this temporary function, a background color or an icon with a particular shape will be used depending on whether or not the function is available, the color or shape therefore being updated at each change of state of the function.

Step 906 is then passed to, in which it is determined whether there is another functional unit, concerning the terminal in question, to be displayed. If such is the case, step 903 is returned to and the process recommences as described above.

In the contrary case, step 907 is passed to, in which it is determined whether there is another terminal for which archived configuration information is not yet displayed. In the affirmative, step 902 is returned to and the process recommences as described above. In the negative, the display process is terminated.

FIG. 10 illustrates the procedure implemented in a terminal for effecting a modification of the configuration memory of the terminal, either when a functional unit is added dynamically to this terminal or following a request for configuration of an existing functional unit by a controller.

The dynamic addition of a new function can be effected for example by means of the insertion of a memory card in the terminal, or by means of downloading via an external network (for example the Internet).

In addition, a request for reconfiguration of an existing functional unit by a controller on the IEEE 1394 bus may be required, for example, in order to update the information relating to the vendor, or for controlling access to this functional unit.

As illustrated in FIG. 10, the modification process commences with step 1001, in which the information relating to the functional unit in question is updated, in particular by updating the subset “Unit_Directory” of the configuration memory (see above, description in relation to FIG. 3).

At the following step 1002, it is determined whether it is a question of a function having a temporary character, by consulting the content of the configuration memory attached thereto (that is to say the subset Unit_Directory) in order to detect therein the presence of extended keys according to the invention.

If such is the case, step 1003 is passed to, in which the state of the temporary function (for example “available” or “non-available”) is initialized, as well as a timer with a value which determines the next change of state of the functional unit, and finally a register is also created, whose value indicates the state of the functional unit. Then step 1004 is passed to.

If during the test 1002, it is determined that it is not a case of a functional unit with a temporary character, step 1004 is passed to directly.

At step 1004, the field “generation” of the subset “Bus Information Block” of the terminal is modified, in accordance with the supplement IEEE 1394.a-2000, section 8.3.2.5, so that the controller or controllers connected to the IEEE 1394 bus are informed of a modification to the configuration memory of this terminal when the following bus initialization phase (Bus Reset) appears.

Finally, at step 1005 which follows, the re-initialization of the IEEE 1394 bus is brought about by generating a Bus Reset signal on the bus.

In relation to FIG. 11, a description will now be given of the procedure implemented by a controlling terminal in order to issue a command, via the IEEE 1394 bus, to a terminal having a functional unit with a temporary character.

This is a case where a software application running on the controlling device requires the sending of a command to a functional unit (referred to as the “target”) resident in a terminal connected to the IEEE 1394 bus, controlled by the controlling device. For example, in the case of the control of a camera at a distance, it may be a case of a command such as the stoppage of the recording on the cassette loaded in the camera.

As illustrated in FIG. 11, the process of sending a command commences with step 1101, in which the sending of a command to a distant functional unit (that is to say a function) is required.

At the following step 1102 it is determined whether the distant function has a temporary character. This is performed by consulting, in the local memory of the controller, archived configuration information which concerns the nodes connected to the bus (see above, description in relation to FIG. 6).

In the negative, the procedure is conventional, and step 1106 is passed to in order to prepare and send the required command.

On the other hand, if the distant functional unit has a temporary character, then step 1103 is passed to, in which it is determined whether the required command is a so-called “special” command.

A “special” command is defined here as being a command making it possible to make a change in configuration of the target functional unit. Thus by way of example, the “1394 Trade Association” (TA), in its document “AVIC Digital Interface Command Set, General Specification”, 15 April 1998, defines a command “WRITE DESCRIPTOR” which makes it possible to effect a complete or partial modification of the configuration memory of a functional unit.

If at step 1103 the required command is determined as being a special command, then step 1106 is passed to. In the contrary case, step 1104 is passed to, in which the state of the functional unit is tested.

If the state of the function is determined as being “non-available”, the command is rejected (step 1105), that is to say the required command is not sent to the target terminal. It is possible to make provision for returning information, for example to the application requesting the request, in order to indicate this rejection to it.

In the contrary case, if the state of the function is “available”, step 1106 is passed to, in which the message containing the command is prepared, and is sent, through the IEEE 1394 interface of the controller, to the source terminal. The procedure for issuing a command to a distant functional unit then terminates.

Correlatively, in relation to FIG. 12, a description will now be given of the process implemented in a terminal connected to an IEEE 1394 bus, when the latter receives a command sent by a distant controller to a functional unit with a temporary character, incorporated in the terminal.

As illustrated in FIG. 12, the process commences with step 1201, in which the terminal receives, through its IEEE 1394 interface, a command addressed to a functional unit with a temporary character incorporated in the terminal.

At the following step 1202, the state of the function is determined by consulting the appropriate (state) register. If the functional unit is in the “available” state, the command is executed (step 1204), and the process is then terminated.

Conversely, if the functional unit is in the “non-available” state, step 1203 is passed to, in which it is determined whether the command received is a “special” command (with the same sense as with FIG. 11).

If such is the case, this special command is executed (step 1204). In this case, the execution of the special command gives rise, as mentioned above, to a modification to the configuration of the functional unit; this modification is effected according to the procedure described above in relation to FIG. 10.

In the contrary case, that is to say if the command is not a special command, the command is rejected (step 1205) since the functional unit is in the “non-available” state.

This rejection of the command can take the form of the sending of an error message, to the node issuing the command. The process is then terminated.

Naturally, many modifications can be made to the embodiments described above without departing from the scope of the invention. In particular, although the embodiments described here apply to IEEE 1394, the invention applies in general terms to any other serial bus standard whose information communication mode is similar to that specified in the context of IEEE 1394.

1. A method of configuring a functional unit in a terminal connected to a communication network, the functional unit being configured in accordance with configuration information contained in a configuration memory of said terminal, said configuration memory being accessible remotely through the network by means of at least one controlling node, the method comprising, when the functional unit to be configured has a temporary character relating to its state of functioning vis-a-vis the network, a step of:
creating, in said configuration memory, at least one first item of information characteristic of an action to be applied to said functional unit, and at least one second item of information specifying the nature of the temporary character of said action,
a controlling node thus being able, by accessing said first and second items of information, to take into account automatically a change of state of said functional unit.

2. A method according to claim 1, in which said action consists of changing the state of the functional unit relating to its availability on the network, and the nature of the temporary character consisting of the definition of a duration relating to the validity and time of each possible state of the functional unit.

3. A method according to claim 2, including in addition a step of initializing the functional unit, said initialization step comprising the creation of a memory register whose value is indicative of the current state of the functional unit, and a timer whose expiry triggers a change in state of the functional unit.

4. A method according to claim 2, in which the duration relating to the validity in time of a state of the functional unit can be defined: by reference to one or more precise dates; periodically in time; by a fixed duration; or by any combination of the above three definition modes.

5. A method according to claim 2, in which the state of the functional unit is available or non-available.

6. A method according to claim 1, in which said first and second items of information are structured in the configuration memory according to a format using a set of extended keys.

7. A method of reading, by a controlling node connected to a communication network, the configuration memory of a terminal connected to said network, said terminal being able to include at least one functional unit having a temporary character, configured according to a method according to claim 1, the reading method comprising:
(a) a step of sending, by the controlling node, a request to read configuration information relating to at least one functional unit of the terminal;
(b) a step of receiving, by the controlling node, said configuration information, and of saving said information;
(c) a step of analyzing the saved information and of determining a temporary character of at least one functional unit corresponding to said information;
(d) for each functional unit whose character is determined as being temporary, a step of storing the initial state of the functional unit, and of updating automatically the state stored according to said saved configuration information, by means of which the change in state of the functional unit is thus automatically taken into account in the controlling node.

8. A method according to claim 7, in which step (d) includes the creation of a register whose value is indicative of the initial state of said functional unit, and the creation of a timer whose expiry triggers, in the controlling node, an update of the value of said register.

9. A method of supplying configuration information, said information being saved by a controlling node in a communication network, said configuration information concerning functional units incorporated in a plurality of terminals connected to said network, said information having been obtained by a configuration method according to claim 1, said method of supplying information comprising the following steps, implemented for each of said terminals:
(a) a step of extracting, from the memory of said controlling node, the terminal configuration information;
(b) a step of creating a first window on a display screen, in which general information relating to the terminal is displayed, making it possible particularly for a user to identify the terminal in question as well as the functional unit or units incorporated therein;
(c) a step of creating in the window as many first distinct icons as there are functional units in the terminal, the specific information relating to a particular functional unit being accessible to the user by selecting the corresponding icon by means of an adapted selection device.
(d) a step of determining the character, temporary or not, of each of the said functional units and a step of creating, for each of the functional units determined as having a temporary character, an additional icon displayed close to the first corresponding icon, said additional icon indicating this temporary character, the information relating to the temporary character of the functional unit in question being accessible to the user by selecting the corresponding icon by means of an adapted selection device.

10. A method according to claim 9, in which each additional icon can be represented in two different colors, each of the colors indicating a different state of the corresponding temporary functional unit.

11. A method of processing a command by a controlling node connected to a communication network, said command being intended for a terminal connected to said network, said terminal having at least one functional unit with a temporary character, and being configured according to a configuration method according to claim 1, the processing method comprising:
(a) a step of producing in the controller a request to send a command to a functional unit of said terminal;
(b) a step of determining the temporary character or otherwise of said functional unit;
(c) a step of sending the command if said functional unit does not have a temporary character; or otherwise
(d) if said functional unit has a temporary character, a step of determining whether the command is a so-called “special” command, that is to say one aimed at effecting a change in configuration of the said functional unit;
(e) a step of sending the command to said terminal if said command is a special command; or otherwise
(f) a step of determining the state of said functional unit;
(g) a step of sending the command to said terminal if the state of said functional unit is determined as being “available”; or otherwise
(h) a step of rejecting the command.

12. A method of processing, by means of a terminal connected to a communication network, a command received via said network, said command being intended for a functional unit incorporated in said terminal, said functional unit having a temporary character, and being configured according to a configuration method according to claim 1, the processing method comprising:
(a) a step of determining the state of said functional unit;
(b) a step of executing the command if the state of said functional unit is determined as being available; or otherwise
(c) determining whether the command is a special command, that is to say one aimed at effecting a change in configuration of said functional unit;
(d) a step of executing the command if said command is a special command; otherwise
(e) a step of rejecting the command.

13. A method according to claim 1, in which said communication network is a network with an architecture based on at least one IEEE 1394 serial bus.

14. A device for configuring a functional unit incorporated in a terminal connected to a communication network, having means adapted to implement a configuration method according to claim 1.

15. A device for reading the configuration memory of a terminal connected to a communication network, said device being incorporated in a controlling node connected to said network, having means adapted to implement a reading method according to claim 7.

16. A device for supplying configuration information, said information being saved by a controlling node in a communication network, having means adapted to implement a method of supplying configuration information according to claim 9.

17. A device for processing a command by a controlling node connected to a communication network, said command being intended for a terminal connected to said network, having means adapted to implement the method of processing a command according to claim 11.

18. A device for processing, by means of a terminal connected to a communication network, a command received via said network, having means adapted to implement a method of processing a command according to claim 12.

19. A device according to claim 14, in which said communication network is a network with an architecture based on at least one IEEE 1394 serial bus.

20. A computer system connected to a communication network, for example a network with an architecture based on at least one IEEE 1394 serial bus, comprising a device according to claim 14 and/or a device according to claim 15 and/or a device according to claim 16 and/or a device according to claim 17 and/or a device according to claim 18.

21. A communication network having at least one computer system according to claim 20.

22. A computer program, containing instructions adapted to implement a method according to claim 1, when said program is loaded and executed in a computer.

23. A computer readable information carrier, containing a computer program according to claim 22.
